(19) United States
(12) Patent Application Publication
(10) Pub. No.: US 2015/0264232 A1
(43) Pub. Date: Sep. 17, 2015

(54) MULTI-LENS VIDEO CAMERA MODULE

(71) Applicant: SUYIN OPTRONICS CORPORATION, New Taipei City (TW)

(72) Inventor: Ban Yang, New Taipei City (TW)

(73) Assignee: SUYIN OPTRONICS CORPORATION, New Taipei City (TW)

(21) Appl. No.: 14/210,426

(22) Filed: Mar. 13, 2014

(51) Int. Cl. H04N 5/225

(52) U.S. Cl. CPC H04N 5/2254; H04N 5/2252

(57) ABSTRACT

A multi-lens video camera module includes a holder shell having a planar mounting surface and a plurality of tilted mounting surfaces equiangularly spaced around the periphery, a plurality of lenses respectively mounted in the planar mounting surface and tilted mounting surfaces of the holder shell with respective mounting plates, a PC board mounted in the holder shell and carrying an image synthesis processor IC, flexible flat cables electrically connecting the lenses to the PC board for enabling each lens to transmit a signal to the image synthesis processor IC for image synthesis processing. Thus, by means of calibrating one lens to obtain lens parameters, the other lenses can be rapidly calibrated by a computer using the lens parameters obtained.

### BACKGROUND OF THE INVENTION

1. Field of the Invention

The present invention relates to camera technology and more particularly to a multi-lens video camera module practical for use in a car driving recorder, surveillance equipment or any other video equipment and capable of providing larger than or equal to 180° distortion-free composite images.

2. Description of the Related Art

Multi-lens video camera modules are known. However, when fabricating a multi-lens video camera module, one will encounter a lens calibration problem. Taiwan Utility M435625 discloses a design of dual lens video camera module. According to this design, the two lenses must be calibrated at the same time, complicating the calibrating process. Thus, this design of dual lens video camera module is not suitable for mass production, and has a high failure rate in calibration and a low yield rate.

Further, regular lenses, except fisheye lens (ultra wide-angle lens), cannot obtain larger than or equal to 180° images. However, the use of conventional fisheye lenses cannot eliminate the problem of image distortion to provide larger than or equal to 180° distortion-free images. Thus, conventional multi-lens video camera modules have the common drawbacks of complicated lens calibration and quality problem in mass production.

Further, regular lenses have different image-taking angles. The lenses of an early design simply have a 60° image-taking angle, or an image-taking angle below 90°. For obtaining larger than or equal to 180° images, three conventional lenses of image-taking angle below 90° must be used. Further, because different lenses have different specifications and different image-taking angles, it is difficult to calculate the optimal lens angle.

### SUMMARY OF THE INVENTION

The present invention has been accomplished under the circumstances in view. It is therefore the main object of the present invention to provide a multi-lens video camera module, which comprises a holder shell having a plurality of tilted mounting surfaces equiangularly spaced around the periphery and symmetrically arranged in pair, a plurality of lenses respectively mounted in the tilted mounting surfaces of the holder shell with respective mounting plates, a PC board (printed circuit board) mounted in the holder shell and carrying an image synthesis processor IC, flexible flat cables electrically connecting the lenses to the PC board for enabling each lens to transmit a signal to the image synthesis processor IC for image synthesis processing. Thus, by means of calibrating one lens to obtain lens parameters, the other lenses can be rapidly calibrated by a computer using the lens parameters obtained. Therefore, the invention facilitates lens calibration for mass production.

Further, the contained angle defined between the two tilted mounting surfaces of each pair is calculated through a formula so that the lenses can be optimally arranged for obtaining larger than or equal to 180° distortion-free composite images.

Preferably, the holder shell further comprises a planar mounting surface located at a top side thereof between the two tilted mounting surfaces of each pair of tilted mounting surfaces for the mounting of a supplementary lens to make up the deficiency of the dead angle between each two opposite lenses, avoiding image dead zone in 180° composite images.

Preferably, the holder shell further comprises a plurality of mounting holes located at each tilted mounting surface; each mounting plate comprises a plurality of mounting rods located at a bottom side thereof and respectively press-fitted into the mounting holes at one respective said tilted mounting surface of the holder shell.

Further, the number of said lenses is 2, 3, 4 or 5 for making 180°, or larger than 180°, or 360° panorama composite images.

### BRIEF DESCRIPTION OF THE DRAWINGS

FIG. 1 is an exploded view of a multi-lens video camera module in accordance with a first embodiment of the present invention.

FIG. 2 is an elevational assembly view of the multi-lens video camera module in accordance with the first embodiment of the present invention.

FIG. 3 is a sectional assembly view of the multi-lens video camera module in accordance with the first embodiment of the present invention.

FIG. 4 is a schematic drawing illustrating the optimal contained angle between two symmetric tilted mounting surfaces of the holder shell.

FIG. 5 is a schematic drawing of the first embodiment of the present invention, illustrating the arrangement of the lenses.

FIG. 6 is an elevational assembly view of a multi-lens video camera module in accordance with a second embodiment of the present invention.

FIG. 7 is an exploded view of a multi-lens video camera module in accordance with a third embodiment of the present invention.

FIG. 8 is an elevational assembly view of the multi-lens video camera module in accordance with the third embodiment of the present invention.

FIG. 9 is an elevational assembly view of the multi-lens video camera module in accordance with a fourth embodiment of the present invention.

### DETAILED DESCRIPTION OF THE PREFERRED EMBODIMENT

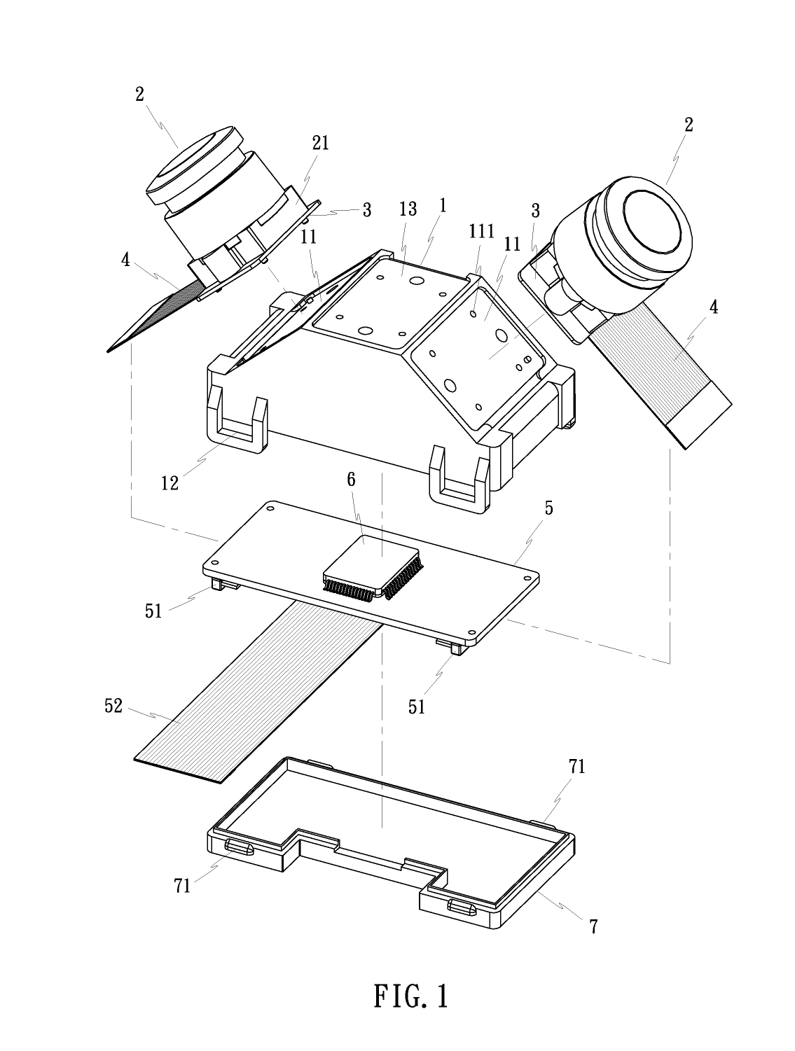

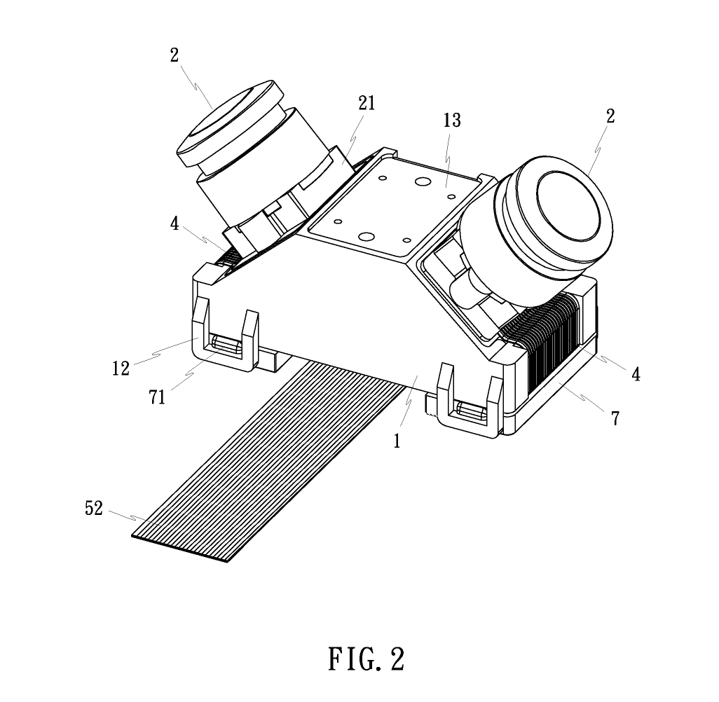

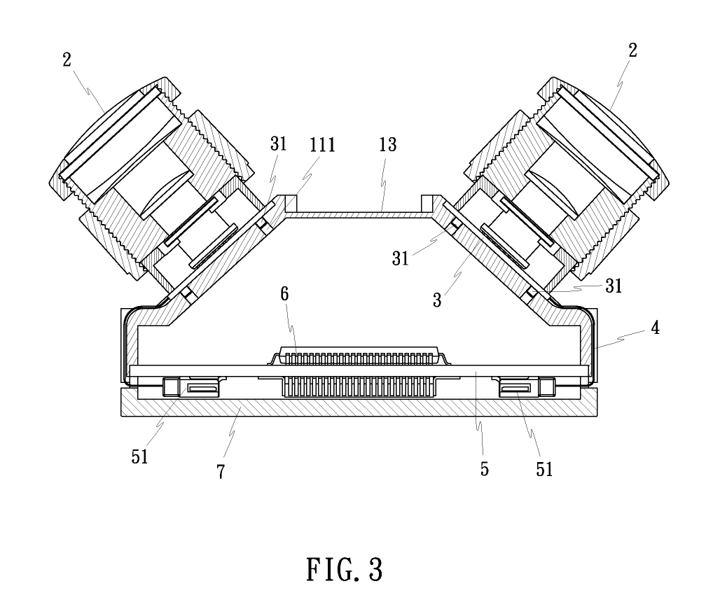

Referring to FIGS. 1-4, a multi-lens video camera module in accordance with a first embodiment of the present invention is shown. The multi-lens video camera module comprises a holder shell 1, a plurality of lenses 2, a plurality of mounting plates 3 mating the lenses 2, a plurality of flexible flat cables 4 mating the lenses 2, a PC board 5, an image synthesis IC Processor 6, and a bottom plate 7 fitting a bottom side of the holder shell 1.

The holder shell 1 comprises at least one pair of tilted mounting surfaces 11 for the mounting of one respective lens 2. The two tilted mounting surfaces 11 of each pair are arranged in a symmetric manner. Each tilted mounting surface 11 has a plurality of mounting holes 111 for accurate positioning of one respective lens 2. The lenses 2 on the two tilted mounting surfaces 11 of each pair are preferably the same.

The lenses 2 can be selected from any type of commercially available lens designs of image-taking angle smaller than (or equal to) 90°, or larger than 90°. Each lens 2 has a base 21 at a bottom side thereof.

The mating mounting plates 3 are respectively joined to respective bottom sides of the bases 21 of the lenses 2. Each mounting plate 3 comprises a plurality of mounting rods 31 located at a bottom side thereof and respectively press-fitted into the mounting holes 111 at one respective tilted mounting surface 11 of the holder shell 1. By means of the mating mounting plates 3, the lenses 2 can be accurately and securely fastened to the respective tilted mounting surface 11 of the holder shell 1.

The mating flexible flat cables 4 are respectively electrically connected to the respective lenses 2 for transmitting signals.

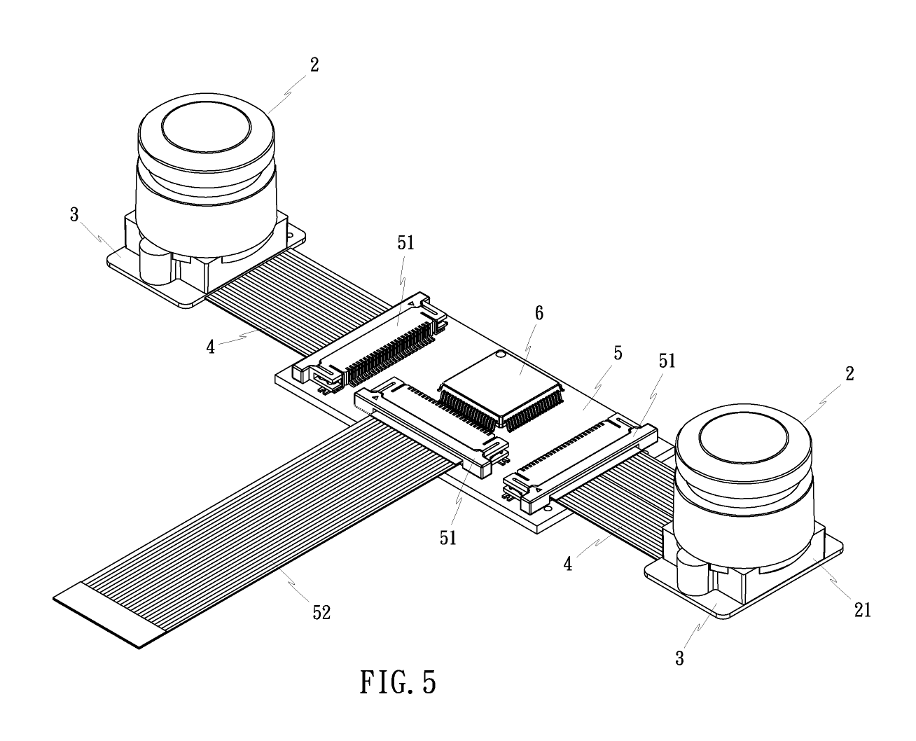

The PC board 5 is mounted in the holder shell 1 and adapted to carry the image synthesis IC Processor 6, comprising a plurality of electrical connectors 51 that are respectively electrically connected to the lenses 2 by the mating flexible flat cables 4 (see FIG. 5) so that each lens 2 can transmit signal through the respective flexible flat cable 4 to the image synthesis processor IC 6 for image synthesis processing, and a flexible flat cable 52 for output of synthesized image signal.

The image synthesis processor IC 6 is adapted for collecting and synthesizing signals provided by the lenses 2.

The bottom plate 7 is fastened to the holder shell 1 to block the bottom open side of the holder shell 1. The connection between the bottom plate 7 and the holder shell 1 can be done rapidly by fastening respective retaining blocks 71 at two opposite sides of the bottom plate 7 to respective retaining grooves 12 at two opposite sides of the holder shell 1. However, this connection design is just an example of the present invention but not intended to limit the design of the present invention.

In the above-described first embodiment of the present invention, each lens 2 of the multi-lens video camera module is individually mounted in one respective tilted mounting surface 11 of the holder shell 1. Thus, by means of calibrating one lens 2 to obtain lens parameters, the other lenses 2 can be rapidly calibrated by a computer using the lens parameters obtained. This design facilitates lens calibration for mass production.

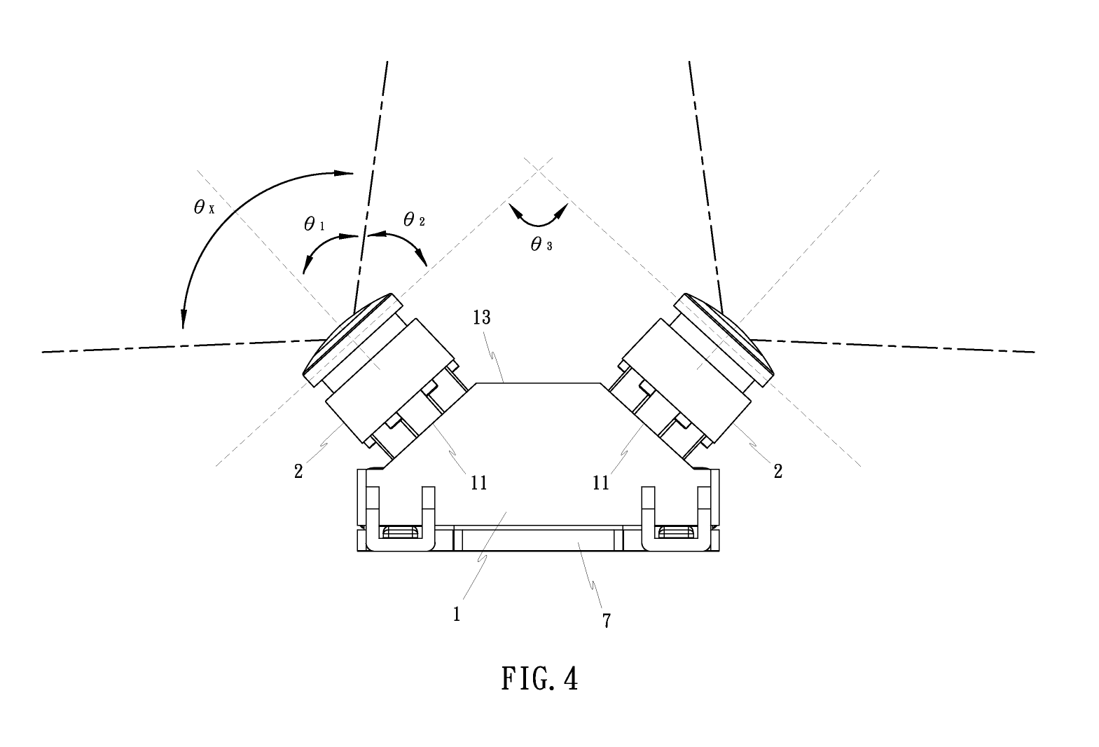

Referring to FIG. 4 again, the optimal contained angle θ₃ between the two symmetrically arranged tilted mounting surfaces 11 of each pair of the holder shell 1 can be calculated through a formula so as to obtain larger than or equal to 180° distortion-free composite images. The formula is as follows:

θₓ=2θ₁;

θ₁+θ₂=90°;

2θ₂+θ₃=180°;

θ₃=180-2θ₂;

θ₃=180−2x(90−θ₁);

θ₃=2θ₁=optimal angle (lens image-taking angle);

thus, θ₃≧lens image-taking angle>90°;

In order to get 180° dual lens synthetic images, and because image synthesis must have overlapping blocks for joining, the lens image-taking angle θₓ (=2θ₁) of the lens 2 must be greater than 90°; θ₃ that is the contained angle defined between the two tilted mounting surfaces 11 of the holder shell 1 is designed to be≧lens image-taking angle θₓ for creating an image overlapping blocks, the higher the value, the more the overlap; on the contrary, if θ₃ is smaller than the lens angle θₓ, it may not produce overlapping images.

wherein:

θ_{X}: the image-taking angle of each lens 2;

θ₃: the contained angle between two symmetric lenses 2;

(θ₃=the contained angle between two symmetric tilted mounting surfaces 11);

the center line of the image-taking angle of each lens 2 extends perpendicular to the associated tilted mounting surface 11;

θ₂: the contained angle between the sideline of the image-taking angle of each lens 2 and the associated tilted mounting surface 11.

In addition to the tilted mounting surfaces 11, the holder shell 1 further comprises a planar mounting surface 13 located at a top side thereof between the two tilted mounting surfaces 11 of each pair of tilted mounting surfaces 11 for the mounting of a supplementary lens 2 to make up the deficiency of the dead angle between each two opposite lenses 2, in order to avoid image dead zone in 180° composite images.

Further, the number of the lenses 2 is at least 2, for example, 2, 3, 4 or 5, for making 180°, or larger than 180°, or 360° panorama composite images.

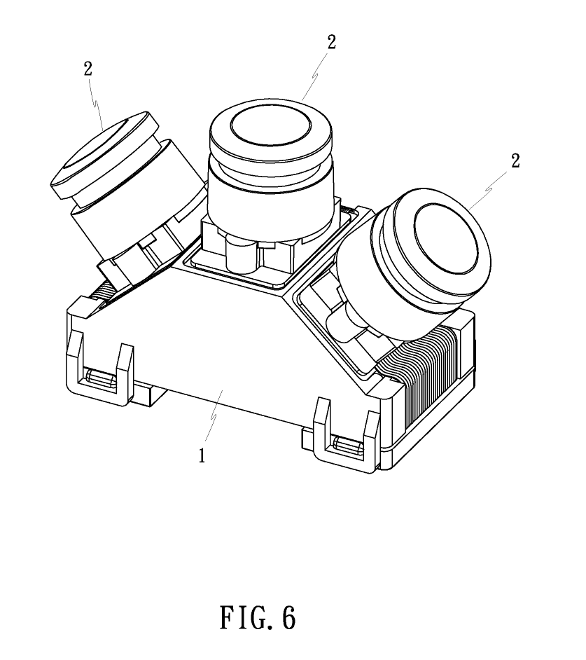

In a second embodiment of the present invention, as shown in FIG. 6, three lenses 2 are installed in the holder shell 1 in such a manner that the first and the second lenses 2 are respectively mounted at two symmetric tilted mounting surfaces of the holder shell 1, and the third lens 2 is mounted at the planar mounting surface at the top side of the holder shell 1 to make up the deficiency of the dead angle between the first and second lenses 2, avoiding image dead zone in composite images.

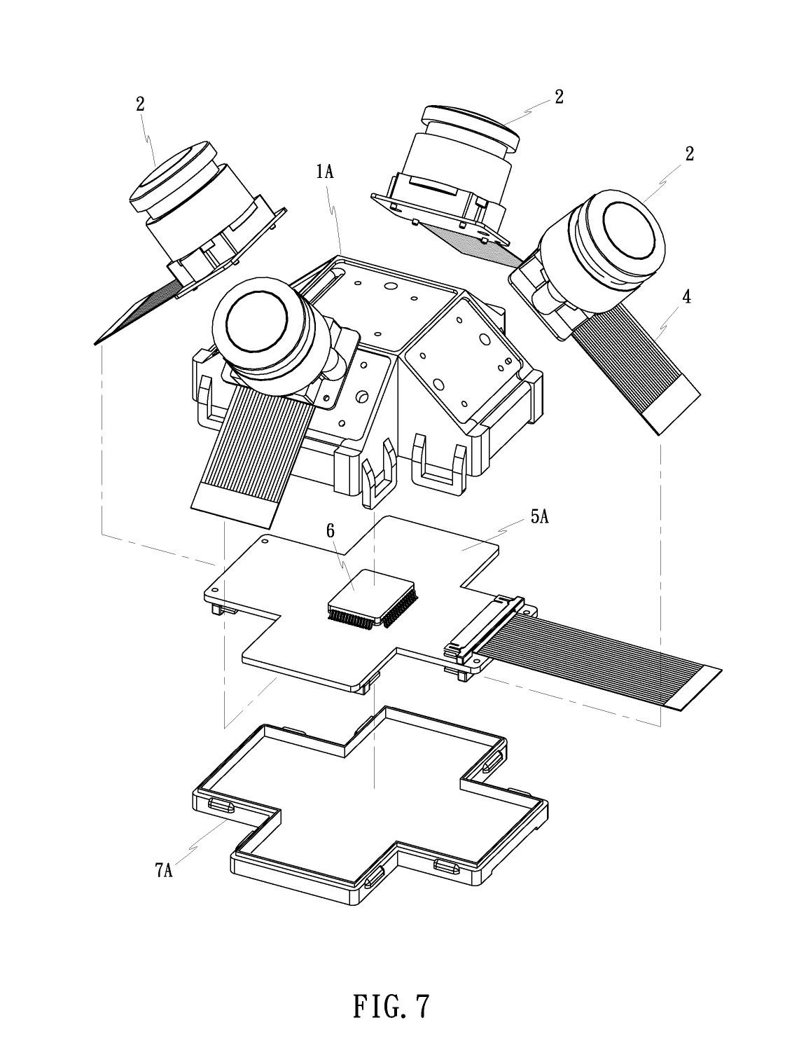

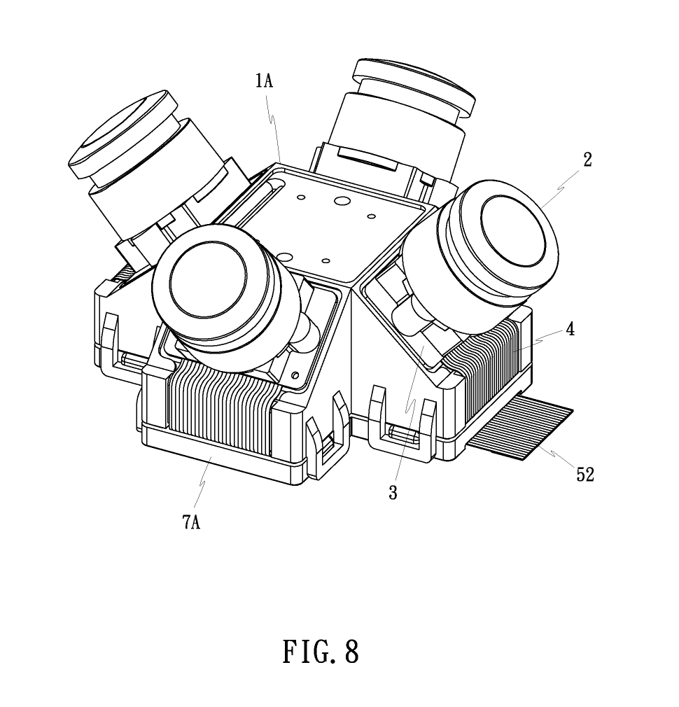

FIGS. 7 and 8 illustrate a multi-lens video camera module in accordance with a third embodiment of the present invention. According to this third embodiment, 4 pieces of lenses 2 are used. This third embodiment is substantially similar to the aforesaid first embodiment with the exception that the holder shell 1A is configured for holding 4 pieces of lenses 2; the PC board 5A and the bottom plate 7A are configured to fit the configuration of the holder shell 1A.

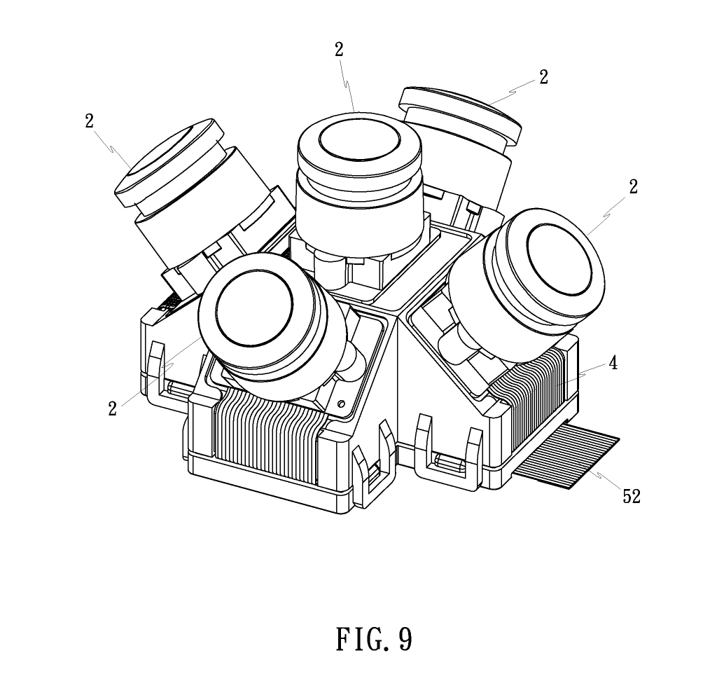

FIG. 9 illustrates a multi-lens video camera module in accordance with a fourth embodiment of the present invention. This fourth embodiment is substantially similar to the aforesaid third embodiment with the exception that an additional supplementary lens 2 is mounted at the planar mounting surface at the top side of the holder shell to make up the deficiency of the dead angle among the other four lenses 2, avoiding image dead zone in composite images.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A multi-lens video camera module, comprising a holder shell, a plurality of lenses, a plurality of mounting plates mating said lenses, a plurality of flexible flat lens cables mating said lenses, a PC board and an image synthesis IC Processor, wherein:
said holder shell comprises at least one pair of tilted mounting surfaces, the two said tilted mounting surfaces of each said pair being symmetrically disposed opposite to each other for supporting said lenses individually;
each said lens comprises a base at a bottom side thereof;
each said mounting plate is affixed to the base of one said lens for fastening to one respective tilted mounting surface of said holder shell;
each said flexible flat lens cable has one end thereof electrically connected to one said lens and an opposite end thereof electrically connected to said PC board for transmitting signals;
said PC board is mounted inside said holder shell and adapted to carry said image synthesis IC Processor, said PC board comprising a plurality of electrical connectors respectively electrically connected to said lenses by said flexible flat lens cables for enabling each said lens to transmit a signal through one respective said flexible flat lens cable to said image synthesis processor IC for image synthesis processing, and a flexible flat output cable electrically connectable to an external device for the output of a synthesized image signal provided by said image synthesis processor IC; and
said synthesis processor IC is mounted at said PC board and adapted for collecting and synthesizing image signals provided by said lenses and outputting synthesized image signals through the flexible flat output cable of said PC board.

2. The multi-lens video camera module as claimed in claim 1, further comprising a bottom plate fastened to said holder shell to block a bottom open side of said holder shell.

3. The multi-lens video camera module as claimed in claim 1, wherein said holder shell further comprises a plurality of mounting holes located at each said tilted mounting surface; each said mounting plate comprises a plurality of mounting rods located at a bottom side thereof and respectively press-fitted into the mounting holes at one respective said tilted mounting surface of said holder shell.

4. The multi-lens video camera module as claimed in claim 3, wherein said holder shell further comprises a plurality of retaining grooves symmetrically disposed at two opposite sides thereof; said bottom plate comprises a plurality of retaining blocks respectively forced into engagement with said retaining grooves of said holder shell.

5. The multi-lens video camera module as claimed in claim 1, wherein the two tilted mounting surfaces of each said pair define a contained angle, and the contained angle is equal or larger than the image-taking angle of said lenses associated with the two tilted mounting surfaces, and the image-taking angle is larger than 90°.

6. The multi-lens video camera module as claimed in claim 1, wherein said holder shell further comprises a planar mounting surface horizontally located at a top side thereof; a supplementary lens is mounted at said planar mounting surface of said holder shell and electrically connected to said PC board.

7. The multi-lens video camera module as claimed in claim 1, wherein the number of said lenses is 2 or 4.

8. The multi-lens video camera module as claimed in claim 6, wherein the total number of said lenses and said supplementary lens is 3 or 5.
